(19) United States
(12) Patent Application Publication
(10) Pub. No.: US 2015/0254598 A1
(43) Pub. Date: Sep. 10, 2015

(54) System for Task Creation in a Project Management Environment

(71) Applicants: Kenneth Engels, Brooklyn, NY (US); Unha Engels, Brooklyn, NY (US); Steven Eisenberg, San Diego, CA (US); Usanisa Setboonsarng, Portland, OR (US)

(72) Inventors: Kenneth Engels, Brooklyn, NY (US); Unha Engels, Brooklyn, NY (US); Steven Eisenberg, San Diego, CA (US); Usanisa Setboonsarng, Portland, OR (US)

(21) Appl. No.: 14/637,569

(22) Filed: Mar. 4, 2015

Related U.S. Application Data
(60) Provisional application No. 61/947,972, filed on Mar. 4, 2014.

(51) Int. Cl. G06Q 10/06; G06Q 50/24

(52) U.S. Cl. CPC G06Q 10/063114; G06Q 50/24

(57) ABSTRACT

A method of managing a project including identifying a main event relating to the project, the main event having a main event date; storing the main event date, identifying a task relating to the main event, identifying whether the relative due date of the task must be before, after, or concurrent with the main event date, and storing before-after-day-of data, identifying whether the relative due date of the task must be exactly a number of days before or after the main event, at least a number of days before or after the main event, or any time before or after the main event, and storing any-exactly-within data, using the main event date, the before-after-day-of data and the any-exactly-within data to calculate a due date for the task, and recalculating the due date for the task based on a change input by a user to the main event date.

### CROSS-REFERENCE TO RELATED PATENT APPLICATIONS

This application claims the benefit of U.S. Provisional Patent Application No. 61/947,972, filed Mar. 4, 2014 entitled “System for Task Creation in a Project Management Environment,” which is incorporated herein by reference in its entirety.

### BACKGROUND

Existing project management solutions in the art lack both cohesion and ease of use. Project management solutions are often ad hoc and primitive, being limited to manual flowcharting or lists of dates and milestones that are unrelated in the software. They fail to reflect the cohesive nature of the project, its milestones, and its related tasks. They also fail to facilitate the teamwork involved in executing the project or account for the different roles played by each team member.

In the prohealth care field in particular, wherein care for a patient is a type of project, computer-based tools for patient care replicate the paper files they were created to replace. They do not focus on ongoing treatment plans for a patient. There is no central repository, for a given patient, in which the patient can see each diagnosis, and below that each treatment, and below that each event, and below that each task related to each event. There is no system where the treatments, events, and tasks are aggregated so the patient, doctor, or staff can see them in different orders, including a chronological calendar view, and wherein professionals on the team can see if different treatment plans are in medical conflict. There is no system where different events are related, so that a change in one—for instance, a date or scheduling change—is propagated to change others.

Accordingly, it would be useful in the art if a hierarchical object oriented project management solution would focus on the project and its components in an interrelated manner, and present the project visually so that the different members of the team in different roles could see and interact with the data in a manner that suits their role in the project.

### DESCRIPTION OF THE DRAWINGS

FIG. 1 is a flow diagram in accordance with an aspect of the present invention.

FIG. 2 is a flow diagram in accordance with an aspect of the present invention.

FIG. 3 is a flow diagram in accordance with an aspect of the present invention.

FIG. 4 is an example of a user interface element in accordance with an aspect of the present invention.

FIG. 5 is a schematic diagram depicting a representative computer system for implementing and exemplary methods and systems for performing automated data breach compliance according to aspects of the present disclosure.

### DETAILED DESCRIPTION

In one aspect of the invention, a patient care management system is disclosed. The system creates the record of the patient himself or herself, with all of the relevant characteristics of the patient represented in the patient data structure.

The system creates a diagnosis for a patient and a treatment plan, said treatment plan comprising a plurality of main events and inter-related tasks.

The system presents patient record data and treatment plan data, allowing the patient, doctor, and other team members to interact with and consume the data in a user friendly manner.

Although the detailed description refers to the health care industry, persons having skill in the art would realize that it could be adapted to project management in other industries, where the “patient” is a recipient of a service and the “doctor” and his team are those providing the services. Similarly, the “patient” may not be a person, but instead a thing that is the object of the project, such as a machine that needs to be constructed, maintained and/or repaired, or a building to be maintained and/or built.

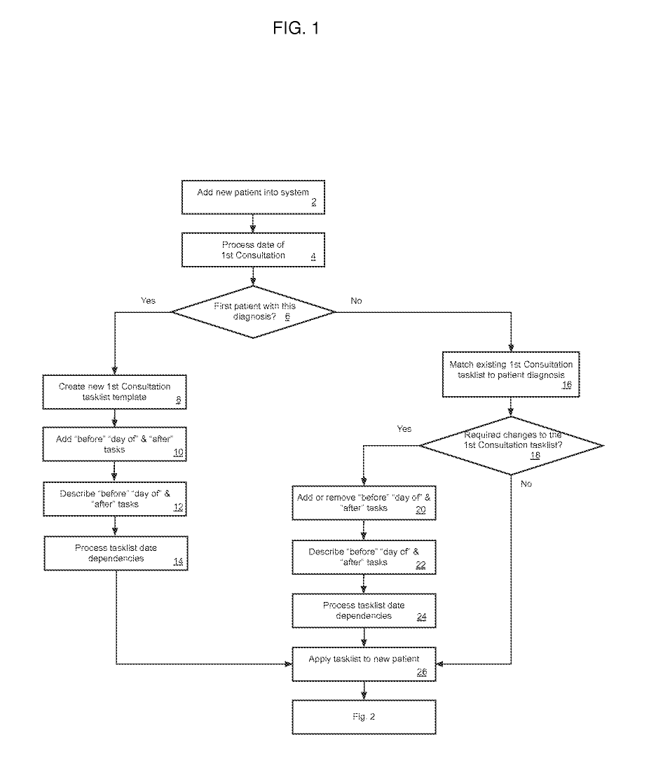

Turning now to the Figures, where like numerals refer to like elements, in FIG. 1 a flow process is shown. At step 2, a new patient is added to the system. In one aspect of the invention, each patient has a unique ID visually represented by a dedicated profile page. When a new patient without prior history at the office is inputted, a series of criteria must be defined before this ID can be finalized. The patient must be given a name, contact information, a referring doctor, a newly assigned doctor and a diagnosis (as shown in step 6, discussed below). After the new patient entry process, a consultation date must be provided in step 4, for when the first appointment will likely occur. Since various circumstances such as test results, insurance approvals, etc. are required before the consultation can be scheduled, the date given at this stage is a tentative one which provides an initial milestone so that the all tasks leading up to the consultation can be created with due dates dependent upon the consultation date, The target date can change at this point, and will be confirmed later. While creating the patient record, the doctor or other service provider selects a diagnosis in step 6. In one aspect of the invention, there is a fixed, pre-populated list of diagnoses types, or the ability to create a new diagnosis. When one patient is tagged with Diagnosis type A, all subsequent patients with the same diagnosis type will then automatically receive a first consultation template (as discussed below) which is identical to the consultation template created upon during the patient record creation step for the first patient with this diagnosis. Therefore, once a patient is added, the system checks to see if his/her diagnosis type already has been assigned. As will be readily apparent for persons having skill in the art, this process flow is not limited to initial consultations but can be repeated for any other treatment plan, as discussed in more detail below.

Existing diagnosis types can have pre-populated objects for first consultations and/or other events. A unique diagnosis type, different from other patients in the system, will result in a new first consultation task list template being created at step 8. The template provides the necessary framework to allow the service providers to populate customized content in the first consultation checklist. In step 10, tasks are added surrounding the initial consultation. When authoring a task list for a first consultation appointment, all tasks exist in direct relation to the targeted consultation appointment date, which is the “main event” of this iteration. Tasks can be set to occur before the target date, on the day of the target date or after the target date. The task list therefore is comprised of all actions that need to be completed leading up to and following the appointment. Regardless of when they occur, these tasks are important in fulfilling all requirements necessary for a successful preparation and assessment of the consultation visit.

In step 12, more detail is added around the timing of each “before” and “after” task. “Day of the consultation” tasks do not require these specifications as it is already implied when they must occur. When adding “Before the consultation” tasks, in one aspect, the invention requires the provider to specify when the task needs to occur, relative to the consultation. Tasks can either occur on an exact day relative to the consultation (such as “exactly 2 days before the appointment date”), within a range of days relative to the consultation (such as “within 7 days before the appointment date”) or on a more flexible deadline (such as “any time before the consultation”). “After the consultation” tasks also follow this date dependent structure except inverted (any time after, exactly x days after, or within x days after). “Before” and “After” tasks are never given specific dates but rather windows of time revolving around the date of the consultation, or “main event.”

Outside of defining date dependencies, the user must also confirm three more fields to finalize the creation of tasks. All tasks must be titled, which is done in a free-type format. When a task is given a unique title, this title is stored and can be reapplied in subsequent task lists. All tasks must also be tagged based on their priority as “optional” or “required.” Completing optional tasks is not essential during the consultation interval but these tasks are considered nice-to-haves if time and resources allow. Lastly, all tasks must be labeled either as having an “Appointment at this location,” (meaning, the same location where the service providers, e.g. the doctors, provide services) an “Appointment at another location” or “No appointment” Some tasks may require the patient to schedule additional visits while others can be handled independently. For tasks that require in-person appointments, these appointments can either occur in-house or at an external facility. Tasks that are flagged with appointment associations (regardless of whether they are in-house or external) can be scheduled by the user (as discussed below). Then in step 14, the application arranges these tasks based on their chronological order in relation to the appointment date. The earliest tasks (most likely those before the appointment) are shown first. In step 16, if a provider is authoring a first consultation task list for a patient that has the same diagnosis as a previously entered patient, the systems pulls the corresponding pre-authored first consultation task list from the database to be used again.

Patients, like all people, are unique. When an existing task list is matched to a new patient in the system with the same diagnosis, there may or may not be subtle nuances inherent to each individual the user must account for when creating individual's first consultation task list. In step 18, if the provider believes that the existing first consultation task list does not require any changes to be made, they can use that same task list exactly as was previously authored. However, if the user believes that the existing first consultation task list does in fact require changes, the user has the ability to work off of the same previously authored task list. In step 20, there is the availability to change the template task list to include new tasks, edit the criteria of templated tasks, entirely remove templated tasks or a combination of these actions. All changes made during this time will not be permanently applied to the template. The author is only making these customizations for the current patient.

In step 22, during the customization process, when adding new tasks or editing the criteria of templated tasks, defining (or redefining) date dependencies, naming, required/optional tagging and appointment tagging must be completed much like in step 12. In step 24, any additions or changes made in boxes 20 & 22 could potentially rearrange the chronological order of the tasks. The system recalculates the task date dependencies and orders the list as needed.

Once a first consultation task list has been finalized, it is then saved and applied to the particular patient ID in step 26. If this list was created for the first patient with this diagnosis type, future patients will default to this task list.

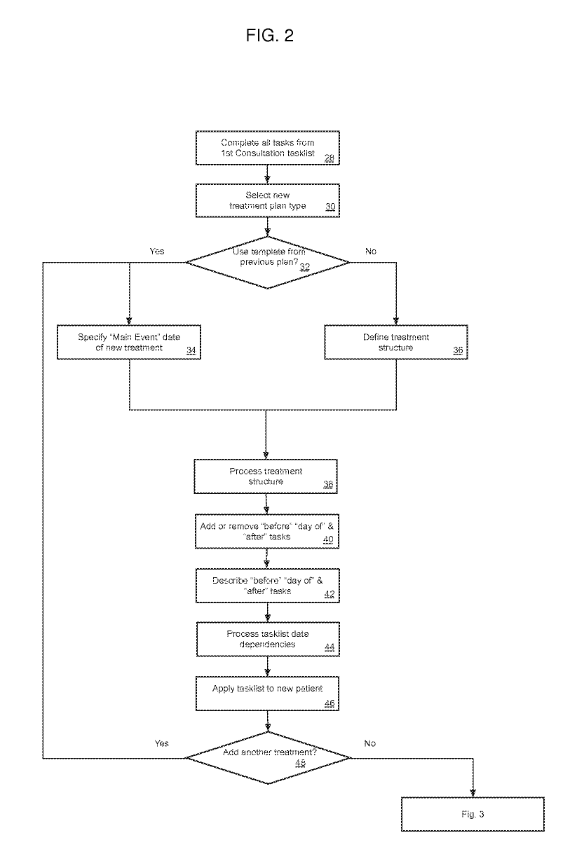

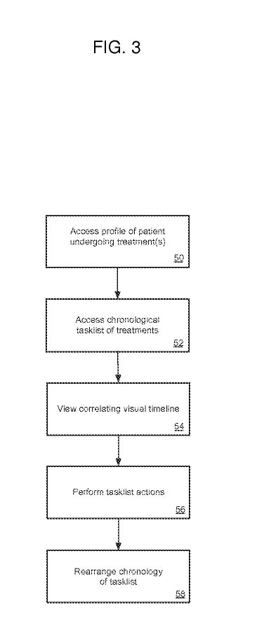

Turning now to FIG. 2, a flow chart for creating a treatment plan is shown. In step 28, completing a first consultation task list essentially means all of the tasks have been “checked off” of the list authored in FIG. 1. This process will be elaborated in FIG. 3 (steps 50-58). A finished first consultation task list means the medical staff is prepared for the patient to visit. A finished consultation visit then means the staff has the proper resources to provide a long term treatment plan.

In step 30, a new treatment type is selected. A provider creates one or more treatment plan types for the patient, depending on the diagnosis or the prognosis. By way of one example, where the patient is diagnosed with cancer, there are six potential types of treatment to choose from: Chemotherapy, Radiation, Oral Therapy, Watchful Waiting, Required Workup or Long Term Task. The database can have other treatment types for other diagnosis, and may contain a module for a provider to create additional treatment types, and/or variations of these treatment type templates. Each treatment type has a unique template structure set-up from which the provider may build task lists relating to the treatment type. These structures and their corresponding task lists are then saved and can be reused as templates for use with future patients with similar diagnosis and/or prognosis.

In step 32, The user can either select a previous treatment structure or create a new one. If the latter is selected, a template will form from the result. If the user chooses to use a template from a previous plan, then the process moves to step 34, wherein a “Main Event” date of new treatment is specified. Each treatment type has its own “main event” from which tasks revolve around in the before/day of/after construct. Users are restricted to use the main events provided. By way of example, some main events are as follows: Chemotherapy/First Day of Chemotherapy, Radiation/First Day of Radiation, Oral Therapy/Check Up Appointment, Watchful Waiting/Check Up Appointment, Required Workup/[Today's Date], Long Term Task/[Date of Task].

When choosing a template from a previously authored plan, the user must specify the target date for when the appropriate main event will occur. Without this date, the system does not allow for task list creation or customization.

If the provider chooses not to use a template from a previous plan, the provider begins the process of creating a new template in step 36. When creating a task list from a blank canvas, the provider must first define the structure of the treatment type. Each treatment type can have a unique structure set-up. Once structures are built (and their associated task lists are built), they can be accessed from the saved template list and reused as shown in steps 32-34. By way of example, the Chemotherapy structure first requires naming the treatment plan. This is a free-type naming process by the user but the plan will have a name akin to the type of chemo regimen (i.e. TC, TAC, Tamoxifen, etc.). Chemo treatments operate in regimented cycles. The provider must list how many cycles will occur and how often these cycles occur (for instance—repeat 3 times, once every 3 weeks). Lastly, the provider must set a target date for the main event of the first cycle (like box 34).

Once the initial structure set-up is confirmed or created, the system calculates the target dates for the remaining main events depending on the number of cycles and frequency indicated in step 38. For example, if January 1 is the indicated target main event (chosen in boxes 34 or 36) and there are 4 total cycles occurring every 2 months, the system will make the following calculations: Main Event 2=March 1, Main Event 3=May 1, Main Event 4=July 1. These dates are all target dates which must be independently confirmed at a later stage.

Much like step 20 in FIG. 1, in step 40 “before,” “after,” and “day of” tasks are added. The user makes necessary edits to the pre-authored or new task lists in order to cater to the current patient. Each cycle is sectioned off into its own task list to illustrate which tasks need to be completed for each main event. In step 42, the “Before” “Day of” & “After” tasks are described. Much like in steps 12 & 22 of FIG. 1, the user defines (or redefines) all criteria of new or updated tasks. However, unlike authoring for a consultation plan which only has one main event (the appointment), there is one extra layer when describing treatment plan types with multiple cycles. The user must also indicate whether a task repeats for all cycles or specific cycles. Doing so speeds up the authoring since you can apply one new task to multiple cycles without having to create the task multiple times for each appropriate cycle. In step 44, much like step 14 of FIG. 1, task lists flexibly re-order themselves in the authoring canvas as date dependencies are built and updated.

The user can customize a task list without any limitations. Once a list has been finalized and saved, it is applied to the current patient and saved as a template for additional patients if/when needed in step 46.

Once a treatment plan and associated task lists have been created, they can be viewed on the patient's treatment plan page in step 48. Task lists are organized in chronological order depending on when they need to be completed in relation to the main event. These lists can then be performed upon as individual tasks are updated and completed. Performance actions will be described in box 56.

Patients can have multiple treatment plans occurring simultaneously. For instance a patient can have chemotherapy running concurrently with radiation treatment. Thus, in step 50, the user is asked whether he wishes to add another treatment. If yes, the user must re-complete boxes 32-48. As more task lists are created, the resulting overall task list (box 48) begins to combine treatment plan tasks which are ordered chronologically. Once the treatments are all entered, and the answer to the question in step 50 is “no, the process shifts to FIG. 3.

Turning now to FIG. 3, a flow chart for the process of accessing patient information that has already been entered is shown. In step 52, access profile of patient undergoing treatment(s)

The task list of a patient is accessible within the patient's profile in the “Treatment Plan” section. The number of tasks presented can be narrowed down to tasks due over the next 30 days, over the next 60 days and all tasks.

As noted in step 50, the task list for a patient can consist of a combination of multiple treatment types. In step 54, a chronological task list of treatments can be shown. In order to differentiate which task goes with which treatment type, there can be color coordination. For instance, chemotherapy is tagged with blue, so all tasks linked to chemotherapy are marked with a blue stroke. Tasks by treatment type can have their visibility toggled on/off by tapping the header panels above the list. As noted above, the chronology of the tasks is dependent upon the main event. In addition to a tasklist of combined treatment plans, there will be a timeline which will illustrate the entire course of treatment in accordance to one aspect of the invention. Treatment plan types have their own individual rows in the chart with Main Event dates on the rows represented by diamond icons. At the header of the chart is a calendar with each column representing a day. The Main Event diamonds fall in the appropriate columns to match the day they are expected to occur. Today's date is also marked in the column to quickly show the distance from these Main Events. While these timelines can not be physically interacted with, they serve as immediate progress indicators that add broader context to the imperative tasks at hand.

Once treatment begins, the task list is used by all staff members to represent progress. Various actions can be performed to denote progress in or towards completion of the task as shown in step 56. Prior to completion, tasks can be tagged with status updates. These updates are from a fixed list of options (such as “Requested” or “Waiting for Authorization”) that provide context for the task. If the default update option is not sufficient, there is a free text option of a maximum of 140 characters to expand context. Tasks can also be scheduled if they were tagged with appointments in the authoring stage (step 12 of FIG. 1). When scheduling, a calendar widget opens allowing for the selection of day & time. Lastly, each task has a checkbox next to it which can be checked to signify that a task has been completed. Tasks can be unchecked if more updates are necessary.

The chronology can be rearranged in step 58, in view of a real-world change such as a time conflict, etc. Before scheduling is enabled for tasks that were tagged with appointments, the main event date must be confirmed to replace the original target date. This confirmation occurs in the header section of the task list. Once a date has been set, the tasks related to this main event can now be scheduled. If the chronology is affected by the new main event date, the task list dynamically rearranges itself. Main event dates can also be changed after confirmation. These changes may require new scheduling for tasks.

For tasks that occur the day of the main event or on exact days before or after the main event, since dates are already implied, only times can be added when scheduling. If the main event date were to ever change, these types of tasks also will also have to change because of their dependencies to the main event.

For tasks that occur any time or within a range of days before or after a main event, a date and time can be added. If the main event changes dates, there is a prompt asking if they should be rescheduled rather than automatically rescheduling.

As tasks are completed or schedules are confirmed, the task list re-orders itself to show the most immediate incomplete tasks at the top.

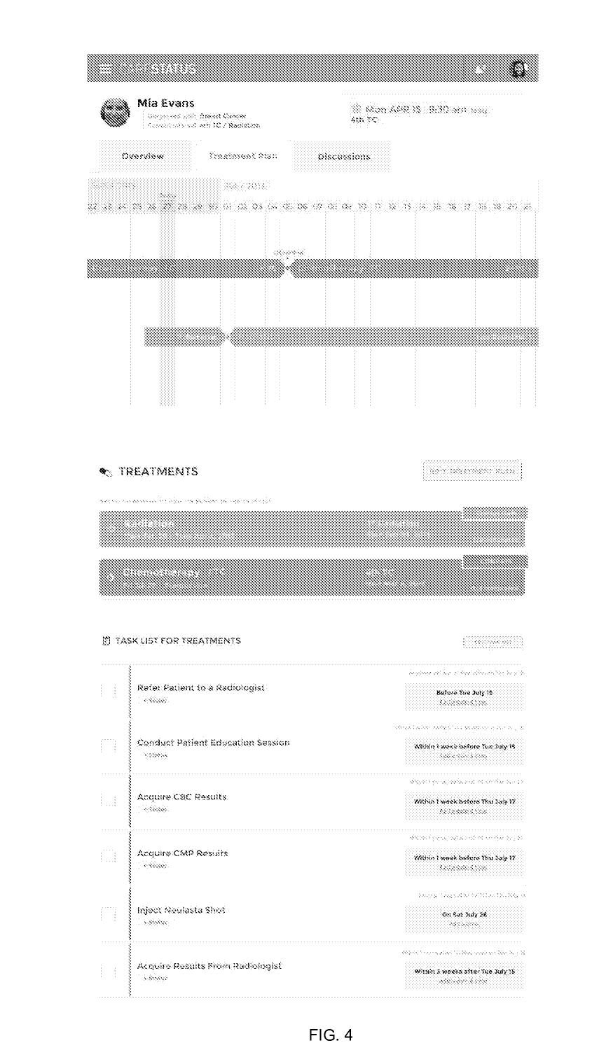

In FIG. 4, a screenshot of the patient view screen in accordance with one aspect of the invention is shown. In the upper area of FIG. 4, the timeline of each treatment plan is shown. In the example shown, a cancer patient is being treated with both chemotherapy and radiation. The different tasks and events for each treatment plan are shown in the time line. In accordance with one aspect of the invention, each treatment plan timeline will be colored differently. In the lower portion of FIG. 4, the list of tasks for two treatments for the same patient are shown, together, in a unified detailed timeline. This allows each member of the medical team, and/or the patient, to see the tasks in order. As discussed above, any change to a main event of any treatment plan would automatically alter the dates of the dependent tasks, which would be shuffled into the correct chronological order. In accordance with this aspect of the present invention, a patient and/or his/her medical team is given a comprehensive chronological look at the patient's treatment timeline.

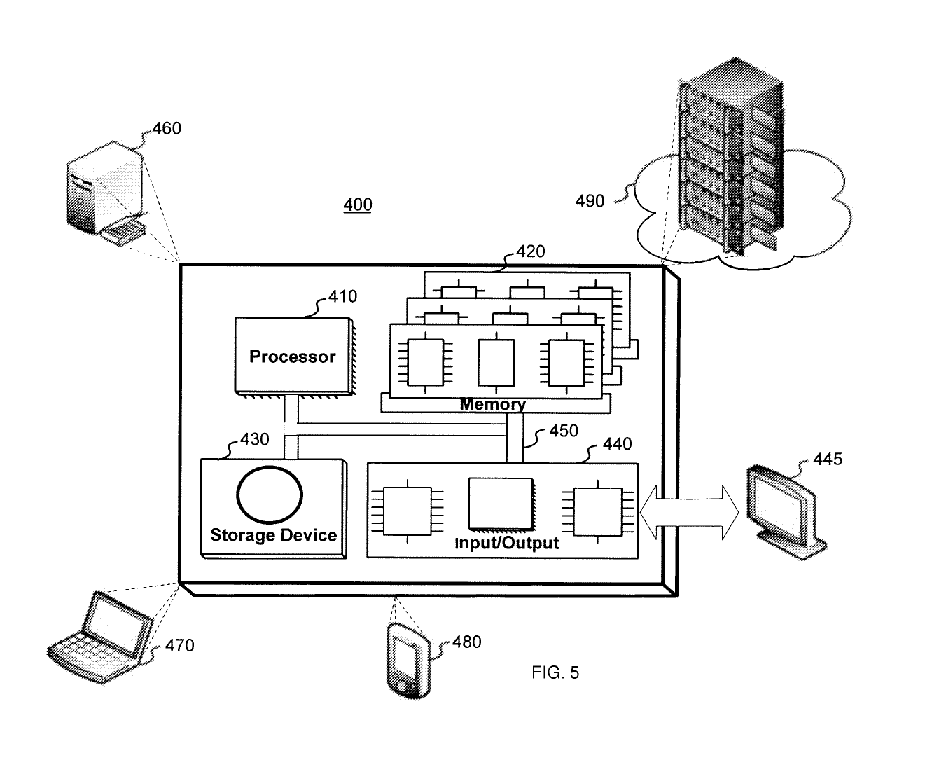

FIG. 5 shows an illustrative computer system 400 suitable for implementing methods and systems according to an aspect of the present disclosure. The computer system may comprise, for example, a computer running any of a number of operating systems. The above-described methods of the present disclosure may be implemented on the computer system 400 as stored program control instructions.

Computer system 400 includes processor 410, memory 420, storage device 430, and input/output structure 440. One or more input/output devices may include a display 445. One or more busses 450 typically interconnect the components, 410, 420, 430, and 440. Processor 410 may be a single or multi core.

Processor 410 executes instructions in which aspects of the present disclosure may comprise steps described in one or more of the Figures. Such instructions may be stored in memory 420 or storage device 430. Data and/or information may be received and output using one or more input/output devices.

Memory 420 may store data and may be a computer-readable medium, such as volatile or non-volatile memory, or any non-transitory storage medium. Storage device 430 may provide storage for system 400 including for example, the previously described methods. In various aspects, storage device 430 may be a flash memory device, a disk drive, an optical disk device, or a tape device employing magnetic, optical, or other recording technologies.

Input/output structures 440 may provide input/output operations for system 400. Input/output devices utilizing these structures may include, for example, keyboards, displays 445, pointing devices, and microphones—among others. As shown and may be readily appreciated by those skilled in the art, computer system 400 for use with the present disclosure may be implemented in a desktop computer package 460, a laptop computer 470, a hand-held computer, for example a tablet computer, personal digital assistant, mobile device, or smartphone 480, or one or more server computers that may advantageously comprise a “cloud” computer 490.

What is claimed is:

1. A method of managing a project comprising identifying a main event relating to the project, the main event having a main event date;
storing main event data including the main event date;
identifying at least one task relating to the main event;
identifying whether the relative due date of the at least one task must be before, after, or concurrent with the main event date, and storing a first result as before-after-day-of data;
identifying whether the relative due date of the at least one task must be exactly a number of days before or after the main event, at least a number of days before or after the main event, or any time before or after the main event, and storing a second result as any-exactly-within data;
using the main event date, the before-after-day-of data and the any-exactly-within data to calculate a due date for the at least one task; and
recalculating the due date for the at least one task based on a change input by a user to the main event date.
